(19) United States
(12) Patent Application Publication
(10) Pub. No.: US 2017/0253161 A1
(43) Pub. Date: Sep. 7, 2017

(54) STORAGE COMPARTMENT HAVING AN ACCOMMODATING SPACE FOR THE INSERTION AND ACCOMMODATION OF OBJECTS AND HAVING A HOLDER FOR A BEVERAGE CONTAINER

(71) Applicant: fischer automotive systems GmbH & Co. KG, Horb a.N. (DE)

(72) Inventors: Jörg FLOTHMANN, Bondorf (DE); Gunter LEOPOLD, Baiersbronn (DE)

(21) Appl. No.: 15/441,370

(22) Filed: Feb. 24, 2017

(30) Foreign Application Priority Data
Mar. 2, 2016 (DE) 10 2016 103 731.1

(51) Int. Cl. B60N 3/10; B60R 7/04

(52) U.S. Cl. CPC B60N 3/108; B60N 3/101; B60R 7/04

(57) ABSTRACT

A storage compartment having two holders for a beverage container, such as beverage cans, for a central console of a motor vehicle. In order to support a beverage container in a tilt-proof manner, the invention provides four retaining jaws, which are acted upon by spring force, two of which are fixed and two are disposed on two rotating disks, which are disposed one above the other, and therefore the retaining jaws can be moved into positions, which are offset by 90°, as shown on the right in the figure. When not in use, the two movable retaining jaws can be moved (left) to the side under a cover of the storage compartment.

### CROSS-REFERENCE TO RELATED APPLICATION

The present application claims priority under 35 USC §119 to German Patent Application No. 10 2016 103 731.1 filed on Mar. 2, 2016, the entire disclosure of which is incorporated herein by reference.

### TECHNICAL FIELD

The invention relates to a storage compartment having an accommodating space for the insertion and accommodation of objects and having a holder for a beverage container having the features described herein. Such beverage containers are, for example, cups, beverage cans, or drinking bottles. Storage compartments for accommodating small objects such as mobile phones, pens, keys and the like are known. Such storage compartments, which are shell-shaped and often elongate as viewed from above, for installation into, for example, a center console of motor vehicles, are known.

### DESCRIPTION OF THE RELATED ART

A storage compartment having two holders for beverage containers is known from the Chinese patent CN 102 452 346 B. The known storage compartment has the shape of a shell, which, in an intended installation and usage position, is open at the top and is oval as viewed from above, the internal space of which forms an accommodating space, into which objects such as a mobile phone, pens, notepads can be placed for storage. Two circular rotating disks are rotatably mounted on a base of the accommodating space of the storage compartment at both ends of the accommodating space. Rotational axes of the rotating disks are located on central axes of two of semicylindrical shell-shaped side walls at the two ends of the accommodating space. The two rotating disks comprise semicylindrical shell-shaped partitions, which can be moved out of a home position and into a dividing position, and vice versa, by rotating the rotating disks by 180°. In the home position, the partitions of the rotating disks are located on inner sides of the side walls of the accommodating space, and therefore the accommodating space, in the full size thereof, is available for the insertion of objects. In the dividing position, the partitions divide two cylindrical storage regions for two beverage containers in the accommodating space from the rest of the accommodating space, wherein the cylindrical storage regions are surrounded by the semicylindrical shell-shaped side walls of the storage compartment and the semicylindrical shell-shaped partitions of the rotating disks. The rotating disks having the semicylindrical shell-shaped partitions and the side walls of the accommodating space of the storage compartment form the two holders for beverage containers.

In order to allow for adaptation to different diameters of different beverage containers, the known storage compartment comprises flaps at both end faces, which can be swiveled, about axes, which are horizontal and tangential to the storage regions, into the storage regions. The flaps swivel, under spring force, into the storage regions and rest laterally against beverage containers placed into the storage regions, and are pressed outward by the partitions of the rotating disks when the rotating disks, with the partitions, are rotated into the home position. The flaps, which can be swiveled into the storage regions, can also be considered, in general, as support elements for laterally supporting beverage containers placed into the storage regions of the storage compartment.

### SUMMARY

An object of the invention is to provide a storage compartment having at least one divisible storage region for a beverage container of the above-described type, which laterally supports an inserted beverage container at several points on the circumference.

The storage compartment may have the shape of a shell, which, in an intended installation and usage position, is open at the top, the internal space of which forms an accommodating space for the insertion and accommodation of objects. The storage compartment is provided for installation in, for example, a central console of a motor vehicle. Other uses of the storage compartment are not ruled out. The storage compartment comprises a first movable support element for laterally supporting a beverage container, which is guided so as to be movable between a home position and a dividing position. In the home position, the first movable support element is located at one edge or outside the accommodating space of the storage compartment, and therefore the entire accommodating space can be used for the insertion of objects. In the dividing position, the first movable support element is located in the accommodating space and, in fact, in such a way that the element separates one storage region for the insertion of a beverage container from the rest of the accommodating space. The support element can be, for example, shell-, disk-, wall-, or bar-shaped, and a support element similar to a bollard is possible, which is located, in the dividing position, in the accommodating space in such a way that the element, together with a wall of the storage compartment or the accommodating space, separates a storage region, which is open at the top, for the insertion of a beverage container from the rest of the accommodating space. The storage region can be open toward the rest of the accommodating space on either side of the bollard or a comparable support element.

The storage compartment may include a second movably guided support element for laterally supporting a beverage container placed into the storage region, and comprises a driving device, which carries the second movably guided support element along, at least in one direction, during a movement of the first movably guided support element. The driving device can carry the second movably guided support element along during a dividing movement of the first movably guided support element out of the home position and into the dividing position or during a reversed return movement out of the dividing position and into the home position, or in both directions. During a dividing movement of the first movably guided support element out of the home position and into the dividing position, the driving device moves the second movably guided support element into a position, which is spaced apart from the first movably guided support element, at an edge of the storage region and/or during a return movement of the first movably guided support element into the home position at an edge of the accommodating space or out of the accommodating space. A driving device is not intended to mean a rigid, permanent coupling of the first support element to the second support element, for example, by way of the two support elements being integral with one another. The invention makes it possible to bring both of the movably guided support elements into interspaced circumferential points of the storage region, at which the elements provide good lateral support against tilting for an inserted beverage container. If no beverage container has been inserted, the two movable support elements can be moved to one side or out of the accommodating space, and therefore the entire accommodating space can be used for the insertion of objects.

The storage region does not need to be cylindrical, but rather can also be angular, for example. Nor must the storage region be surrounded so as to be closed in the circumferential direction, but rather can have one or more openings and/or can also be formed of only individual, interspaced elements on the circumference thereof. As a result, the support elements can be accommodated in a space-saving manner, for example, adjacent to an edge or outside the accommodating space of the storage compartment.

The movably guided support elements can comprise sliding guides, which are straight, are shaped as circular arcs, or basically extend in any way, for the movable guidance of the elements. A rotatable support about an axis spaced apart from the particular support element, i.e., an eccentric rotatable support, for example, is also possible for movable guidance of the support element or support elements on a circular-arc path. According to one embodiment of the invention, the two movably guided support elements are movably guided on identical paths, i.e., for example, on identical circular arcs.

According to one embodiment of the invention, the movably guided support elements are movably guided in a circumferential direction of the storage region for the beverage container. In the case of a cylindrical storage region, the support elements are movably guided on a circular-arc path along the circumference of the storage region, which is possible not only with a sliding guide but also with the above-described, eccentric rotatable support of the support elements. With the guidance along the circumferential direction of the storage region, the movably guided support elements can be moved into a home position at one edge of the accommodating space of the storage compartment when the elements are not in use. In order to store a beverage container, the first movably guided support element is moved in the circumferential direction of the storage region into the dividing position in the accommodating space, and therefore the element separates the storage region from the rest of the accommodating space. The second movably guided support element moves along with the first movably guided support element in the circumferential direction of the storage region, preferably on a shorter path than the first movably guided support element. The second movably guided support element can likewise move into the accommodating space in order to separate the storage region from the rest of the accommodating space, or the element moves along a circumference of the storage region and along an edge of the accommodating space to a different circumferential point than in the home position, in order to provide lateral support there for a beverage container placed into the storage region.

According to one embodiment of the invention, the driving device carries the second movably guided support element only along a portion of a path of the first movably guided support element, for example, on a final part of the path of the first support element. For example, a driving element is connected to the first movably guided support element, which, after a portion of the dividing movement thereof out of the home position and into the dividing position and/or, vice versa, after a portion of the return movement thereof out of the dividing position and into the home position, strikes the second movably guided support element and carries the element along. This embodiment of the invention ensures that the second movably guided support element travels a shorter path than the first movably guided support element and, during the dividing movement into the dividing position, becomes separated from the first movably guided support element or is separated therefrom to a greater extent, so that the two movable support elements laterally support a beverage container, which has been placed into the storage region, at interspaced circumferential points. During the return movement, this embodiment of the invention makes it possible for the two movably guided support elements to be accommodated next to one another in a space-saving manner in the home position.

According to one preferred embodiment of the invention, the storage compartment comprises, in addition to the two movably guided support elements, at least one further, fixed support element for laterally supporting a beverage container, which has been placed into the storage region of the storage compartment. During a dividing movement of the first movably guided support element into the dividing position, and as the second movably guided support element is carried along the shorter path, the support elements can be distributed uniformly or non-uniformly around the circumference of the storage region, in order to laterally support an inserted beverage container at different circumferential points. The support element or the further, fixed support elements are preferably disposed at the edge of the storage region and at the edge of the accommodating space of the storage compartment.

In order to allow for adaptation to different beverage containers having different diameters, it is provided according to one preferred embodiment of the invention that the support elements can be moved in a supporting direction into the storage region and in an opposite direction out of the storage region. The mobility of the support elements in the support direction and counter thereto should be distinguished from the dividing movement of the first and the second movably guided support elements out of the home position and into the dividing position, and from the return movement in the opposite direction out of the dividing position and into the home position. While the dividing movement and the return movement of the first and the second movably guided support elements proceed, for example, in the circumferential direction of the storage region, the support movement and the movement of the support elements in the opposite direction into and out of the storage region for the purpose of adjusting the diameter proceed transversely to, or at an angle diagonally with respect to, the circumference of the storage region.

In order to move the support elements out of the storage region when not in use, one embodiment of the invention provides a mechanical control mechanism, which forces the support elements out of the storage region during the return movement of the first movably guided support element out of the dividing position and into the home position. The mechanical control mechanism can comprise, for example, a curve control, ramps, cams or the like, which are driven by the return movement of the first movably guided support element out of the dividing position and into the home position, and force the support elements out of the storage region. Preferably, all the support elements are forced out of the storage region, including the first movably guided support element.

### BRIEF DESCRIPTION OF THE DRAWINGS

The invention is described in greater detail in the following with reference to an exemplary embodiment shown in the drawings. Wherein:

FIG. 1 shows a top view of a storage compartment according to the invention, having two holders for beverage containers; and

FIGS. 2 and 3 show a perspective view of support elements and a mechanical control mechanism of the support elements of one of the two holders for a beverage container of the storage compartment in FIG. 1, in a home position (FIG. 2) and in a usage position (FIG. 3).

The drawing is a simplified and schematized depiction for ensuring an understanding of the invention and for describing the invention.

### DETAILED DESCRIPTION OF THE INVENTION

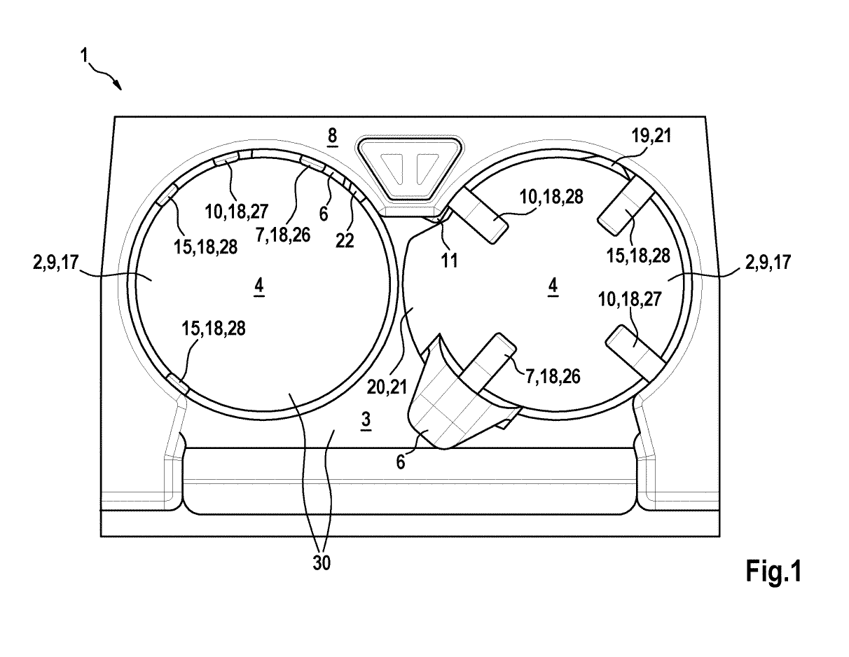

The storage compartment 1 according to the invention, which is depicted in FIG. 1, is provided for installation in, for example, a central console of a non-illustrated motor vehicle. The compartment has the shape of a shell, which is open at the top, in an intended installation and usage position, and has two partial cylinder-shaped bulges 2, which extend through approximately more than 180° and are open toward the storage compartment 1 along the rest of the circumference. An internal space of the storage compartment 1, including the two bulges 2, forms an accommodating space 30 for the insertion and accommodation of objects such as, for example, a mobile phone, a notepad, pens, etc. Two circular rotating disks 4, 5 are disposed concentrically to, and in, the bulges 2, and concentrically to one another, in each bulge 2, on a base 3 of the accommodating space 30 of the storage compartment 1. The two rotating disks 4, 5 are supported so as to be rotatable about the axes thereof as a shared axis of rotation, which is also an axis of the particular bulge 2.

A first retaining jaw 7 is disposed in an upright position in a bollard-like housing 6, at one point on a circumference of an upper of the two rotating disks 4. The first retaining jaw 7 is supported on the upper rotating disk 4, at the bottom and by means of a swivel bearing, so as to be swivelable about a swivel axis, which is horizontal and tangential to the rotating disk 4, and therefore the retaining jaw can be moved at the top, inward and outward, radially with respect to the rotating disk 4. The movement of the retaining jaw 7 radially with respect to the rotating disk 4 is a movement in, or counter to, a support direction. The first retaining jaw 7 is acted upon by a spring element, which is not visible in the drawing and is disposed in the housing 6, toward the inside, i.e., in the support direction in the direction of the axis of the rotating disk 4, which is also the axis of rotation thereof. By way of the rotatable support of the rotating disk 4, the bollard-like housing 6 and the first retaining jaw 7 are movably guided on a circular arcuate path along the circumference of the rotating disk 4. In the exemplary embodiment of the invention, which is depicted and described, the upper rotating disk 4 can be rotated back and forth by approximately 90°. As a result, the bollard-like housing 6 and the first retaining jaw 7 can be moved back and forth on a circular arcuate path by approximately 90° in the circumferential direction between a home position, which is shown on the left in FIG. 1, and a dividing position, which is shown on the right in FIG. 1. The movement out of the home position and into the dividing position is referred to here as a dividing movement, and the movement in the opposite direction out of the dividing position and into the home position is referred to here as a return movement. The radial movement of the retaining jaw 7 in the support direction is perpendicular to the dividing movement and to the return movement in the exemplary embodiment.

The movement of the housing 6 and the retaining jaw 7 proceeds in a circumferential direction of the bulge 2 of the storage compartment 1. In the home position, which is shown on the left in FIG. 1, the housing 6 and the first retaining jaw 7 are located under a cover 8, which surrounds the accommodating space 30 of the storage compartment 1 at the top. In the dividing position shown on the right in FIG. 1, the housing 6 and the first retaining jaw 7 are located approximately in the center of an opening of the bulge 2, which is open toward the accommodating space 30. As a result, the bollard-type housing 6 or the first retaining jaw 7, in the dividing position, separates a cylindrical storage region 9 for the insertion of a non-illustrated beverage container from the rest of the accommodating space 30. Such beverage containers are, for example, a cup, a drinking bottle, or a mug. The storage region 9 is surrounded by the bulge 2 and is separated from the rest of the accommodating space 30 by the bollard-type housing 6 or the first retaining jaw 7. The storage region 9 is open between the bulge 2, which extends through approximately more than 180° in the circumferential direction, and the housing 6 and the first retaining jaw 7, on both sides of the housing 6 and the retaining jaw 7, but the remaining openings on both sides of the housing 6 and the first retaining jaw 7 are so small in the dividing position that a beverage container placed into the storage region 9 is held in the storage region 9.

In the home position of the housing 6 and the first retaining jaw 7, the bulge 2 is open toward the accommodating space 30 of the storage compartment 1, and therefore the entire accommodating space 30, including the storage region or storage regions 9, can be used for accommodating small objects such as a mobile phone, pens and the like. Due to the rotatability of the upper rotating disk 4 about the axis of the partial cylinder-shaped bulge 2 and the arrangement of the housing 6 and the first retaining jaw 7 at one point on the circumference of the rotating disk 4, the housing 6 and the first retaining jaw 7 are movably guided on a circular arcuate path along a circumference of the cylindrical storage region 9 of the storage compartment 1. The storage compartment 1, which is shown and described, comprises two storage regions 9, but embodiments are also possible having one storage region or more than two storage regions 9 for beverage containers.

A second retaining jaw 10 is disposed in an upright position in a housing 11 at a point on a circumference of a lower of the two rotating disks 5, outside an edge of the upper rotating disk 4, and is swivelable, via a swivel bearing, about a swivel axis, which is horizontal and tangential to the rotating disk 5, and therefore the second retaining jaw 10 can be moved at the top, inward and outward, radially with respect to the rotating disk 5. The movement toward the inside and toward the outside is a movement in a support direction and counter to a support direction. The second retaining jaw 10 is also acted upon toward the inside, i.e., in the support direction, by a spring element, which is not visible in the drawing. Due to a rotation of the lower rotating disk 5, the second retaining jaw 10 moves on an identical circular arcuate path as the first retaining jaw 7 along a circumference of the bulge 2 and the storage region 9 for a beverage container.

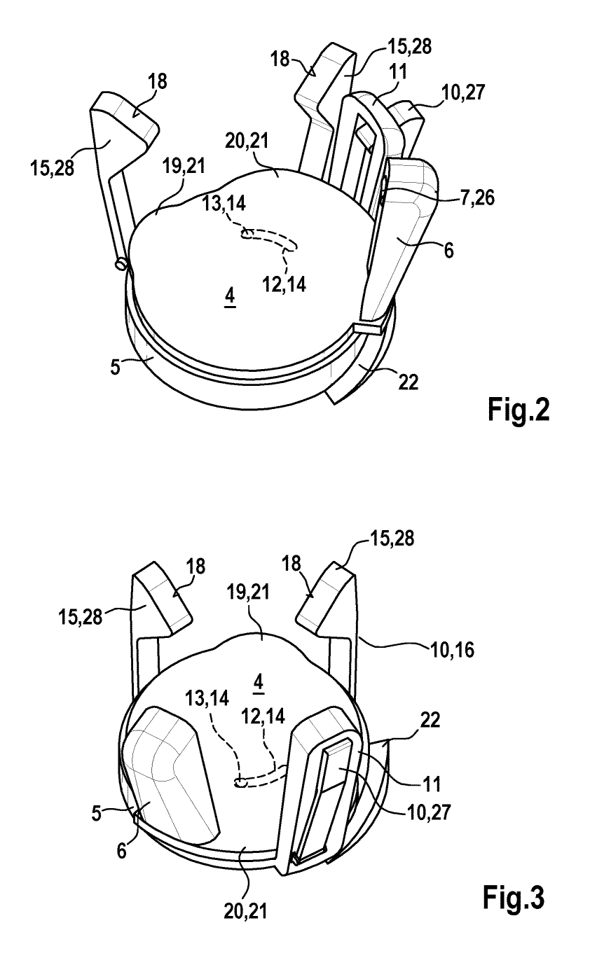

The lower rotating disk 5 has a circular arcuate slot 12, which is concentric to the axis of rotation, into which a driving peg 13 engages, which protrudes downward from the upper rotating disk 4. The slot 12 and the driving peg 13, which are covered by the upper rotating disk 4, are indicated in FIGS. 2 and 3 using dashed lines. FIGS. 2 and 3 show the upper and the lower rotating disks 4, 5, the first and the second retaining jaws 7, 10 in the housings 6, 11 thereof, and two further retaining jaws 15, which are fixed and will be described below, of the storage region 9, which is shown on the left in FIG. 1, for a non-illustrated beverage container. The storage compartment 1 is not shown in FIGS. 2 and 3. FIG. 2 shows the home position, and FIG. 3 shows the dividing position. The right storage region 9 is a mirror image. During the rotation of the upper rotating disk 4 out of the home position and into the dividing position, i.e., the dividing movement, the driving peg 13 strikes one end of the slot 12 after approximately one half of the rotation and then carries the lower rotating disk 5 along, and therefore the lower rotating disk 5 rotates along with the upper rotating disk 4 along a shorter path, namely approximately half the path. During the rotation of the upper rotating disk 4, the bollard-like housing 6 of the first retaining jaw 7, and the first retaining jaw 7, both of which are disposed on the circumference of the first rotating disk 4, move on a circular arcuate path from the home position into the dividing position. This movement is the dividing movement. As a result of the concurrent rotation of the lower rotating disk 5, the housing 11 of the second retaining jaw 10, and the second retaining jaw 10, which are disposed on the circumference of the lower rotating disk 5, move on a circular arcuate path in the circumferential direction of the bulge 2 and the storage region 9, although only approximately half as far as the housing 6 of the first retaining jaw 7, and the first retaining jaw 7. The slot 12 and the driving peg 13 form a driving device 14, which carry the second retaining jaw 10 along with the first retaining jaw 7 on the circular arcuate path in the circumferential direction of the bulge 2 and the storage region 9, although on a shorter path. During the dividing movement of the first retaining jaw 7 from the home position under the cover 8 into the dividing position in the center of the opening of the bulge 2 toward the accommodating space of the storage compartment 1, the second retaining jaw 10 likewise moves from underneath the cover 8 up to one end of the partial cylindrical shell-shaped bulge 2 of the storage compartment 1, which extends in the circumferential direction through approximately more than 180°. At the end of the bulge 2 as well, the second retaining jaw 10 and the housing 11 thereof are still located under the cover 8, as shown on the right in FIG. 1.

During a rotation of the upper rotating disk 4 in the opposite direction, i.e., the reverse movement, the bollard-like housing 6 thereof and the first retaining jaw 7 move out of the dividing position and into the home position under the cover 8 at the one end of the bulge 2, as shown on the left in FIG. 1. During this movement, the bollard-like housing 6 of the first retaining jaw 7 strikes the housing 11 of the second retaining jaw 10 and pushes the second retaining jaw 10, along with the housing 11 thereof, away from the end of the bulge 2 and further under the cover 8.

In the exemplary embodiment of the invention shown, every bulge 2 of the storage compartment 1 comprises two further, fixed retaining jaws 15, but it is not absolutely necessary for the invention that the number of further retaining jaws 15 be two. In the dividing position of the first retaining jaw 7, in which the second retaining jaw 10 is located at the one end of the bulge 2, the total of four retaining jaws 7, 10, 15 are offset with respect to one another by approximately 90° in the circumferential direction at one edge of the storage region 9, as shown on the right in FIG. 1 and in FIG. 3. In the home position of the first retaining jaw 7, in which the bollard-like housing 6 of the first retaining jaw 7 has been pushed against the housing 11 of the second retaining jaw 10 and under the cover 8 of the storage compartment 1, the first retaining jaw 7, the second retaining jaw 10 and one further retaining jaw 15 are located next to one another on a circumference of the bulge 2 and the storage region 9 for a beverage container, as shown on the left in FIG. 1 and in FIG. 2. Due to the fixed arrangement, the two further retaining jaws are still offset by 90° with respect to one another in the circumferential direction.

As is the case with the first and the second retaining jaws 6, 10, the further retaining jaws 15 are also disposed upright on the circumference of the bulge 2 and the storage region 9, and are swivelable, via swivel bearings, about swivel axes, which are horizontal and tangential to the bulge 2 and to the storage region 9, on the bottom on the base 3 of the storage compartment 1, and therefore the further retaining jaws 15 can be moved radially inward and outward at the top, in a support direction and counter to a support direction. As is the case with the first and the second retaining jaws 6, 10, the further retaining jaws 15 are also acted upon in the support direction, being forced inwardly into the storage region 9, by spring elements, which are not visible in the drawing. The mobility of the retaining jaws 7, 10, 15 into and out of the storage region 9 is used for adaptation to different beverage containers having different diameters. Due to the action of the spring force toward the inside, the retaining jaws 7, 10, 15 rest laterally against a beverage container, which has been placed into the storage region 9 and is not shown, and support the container in a tilt-proof manner in the storage region 9 of the storage compartment 1. The retaining jaws 7, 10, 15 can therefore also be referred to, in general, as support elements 26, 27 28 for providing lateral support of a beverage container. The storage regions 9, which can be separated from the storage compartment 1 by means of the bollard-like housings 6 of the first retaining jaws 7, and the retaining jaws 7, 10, 15, which form the support elements 26, 27, 28 for a lateral support of an inserted beverage container, can also be referred to as holders 17 for beverage containers of the storage compartment 1. In the exemplary embodiment, the storage compartment 1 comprises two such holders 17 for beverage containers, although embodiments are also possible that have only one, or more than two, such holders 17 for beverage containers.

The upper edges of the retaining jaws 7, 10, 15 forming the support elements 26, 27, 28 are designed as slanted surfaces 18, which are directed diagonally inward and downward. During insertion of a beverage container into the storage region 9 or holder 17 from above, the beverage container strikes the slanted surfaces 18 and presses the retaining jaws 7, 10, 15, against the action of the spring force thereof, outward and counter to the support direction, and therefore the beverage container can be placed into the storage region 9, between the retaining jaws 7, 10, 15. As stated above, the retaining jaws 7, 10, 15, which are acted upon inwardly by spring force, in the support direction, press laterally from the outside against the beverage container placed therebetween, hold the container in a tilt-proof manner, and compensate for different diameters of different beverage containers. The spring force-induced movement of the first and the second retaining jaws 7, 10 in, and counter to, the support direction, radially with respect to the rotating disks 4, 5, inward into the storage region 9 and, vice versa, out of the region, is transverse to the dividing movement and to the opposite reverse movement of the first and the second retaining jaws 7, 10 due to the rotation of the rotating disks 4, 5 on the circular arcuate paths in the circumferential direction of the bulges 2, storage regions 9 and holders 17 for beverage containers.

The upper rotating disk 4 comprises two cams 19, 20, which protrude outward on the circumference of the disk and have different lengths in the circumferential direction. When the first retaining jaw 7 is in the home position, a short cam of the two cams 19 is located against one of the two further retaining jaws 15 on the inside and presses this jaw outward against the action of the spring force thereof, and therefore the retaining jaw 15 does not protrude inward into the storage region 9, as shown on the left in FIG. 1. When the first retaining jaw 7 is in the home position, a long cam of the two cams 20 is located against one of the other further retaining jaws 15 on the inside and against the second retaining jaw 10 on the inside, and likewise presses these two retaining jaws 10, 15 outward, counter to the support direction, against the action of the spring force thereof, and therefore the jaws do not protrude inward into the storage region 9. If the upper rotating disk 4 is in the dividing position and the lower rotating disk 5 rotates therewith, the cams 19, 20 are offset in the circumferential direction with respect to the retaining jaws 10, 15 (FIG. 3), and therefore the retaining jaws 10, 15 swivel inward, under the action of spring force, in the support direction into the storage region, as shown on the right in FIG. 1. The cams 19, 20 can also be referred to as a mechanical control mechanism 21, which forces the retaining jaws 10, 15, which form the support elements 26, 27, 28 for the lateral support of a beverage container placed into the storage region 9, out of the storage region 9, during the return movement of the first retaining jaw 7 out of the dividing position and into the home position. The cams 19, 20 can also be referred to as control curves of a curve control for the retaining jaws 10, 15 forming the support elements 26, 27, 28.

For the first retaining jaw 7, the storage compartment 1 comprises a fixed ramp 22, which is disposed on the base 3 of the accommodating space 30 between the swivel axis of the swivel bearing of the first retaining jaw 7 and the circumference of the upper rotating disk 4. During the movement of the first retaining jaw 7 out of the dividing position and into the home position, a lower end of the first retaining jaw 7 strikes the ramp 22, which rises in this direction, and slides on the ramp 22. Since the ramp 22 is located within the swivel axis of the retaining jaw 7, the ramp 22 forces the retaining jaw 7 outward, out of the storage region 9, during this movement, against the action of the spring force thereof. The ramp 22 forms a mechanical control mechanism, which forces the first retaining jaw 7 outward out of the storage region 9 during the movement out of the dividing position and into the home position. The ramp 22 can also be referred to as a control curve of a curve control for the first retaining jaw 7.

Although the device has been shown and described with respect to certain embodiments, it is obvious that equivalents and modifications will occur to others skilled in the art upon the reading and understanding of the specification. The device includes all such equivalents and modifications, and is limited only by the scope of the following claims.

### LIST OF REFERENCE CHARACTERS

Storage Compartment Having a Holder for a Beverage Container

1 storage compartment
2 bulge
3 base
4 upper rotating disk
5 lower rotating disk
6 bollard-like housing of the first retaining jaw
7 first retaining jaw
8 cover
9 storage region
10 second retaining jaw
11 housing of the second retaining jaw
12 slot
13 driving peg
14 driving device
15 further retaining jaw
17 holder for the insertion of a beverage container
18 slanted surface
19 short cam
20 long cam
21 mechanical control mechanism
22 ramp
26 first movable support element
27 second movable support element
28 further movable support element
30 accommodating space

1. A storage compartment having an accommodating space for insertion and accommodation of objects, and having a holder for a beverage container, having a first movably guided support element for a lateral support of a beverage container placed into a storage region in the accommodating space of the storage compartment, which can be moved into the accommodating space, in a dividing position, in which the element separates the storage region in the storage compartment from the rest of the accommodating space, and can be moved out of the accommodating space, in a home position at one edge of the accommodating space, wherein the storage compartment comprises a second movably guided support element for laterally supporting a beverage container placed into the storage region of the storage compartment, and comprises a driving element, which moves the second movably guided support element into a position, which is spaced apart from the first movably guided support element, at an edge of the storage region during a dividing movement of the first movably guided support element, and/or moves the element into the home position at an edge of the accommodating space, or out of the accommodating space, during a return movement of the first movably guided support element.

2. The storage compartment according to claim 1, wherein the first and the second movably guided support elements are guided on identical paths.

3. The storage compartment according to claim 1, wherein the first and/or the second movably guided support element is movably guided on a circular arcuate path by means of a rotatable support, which is eccentric with respect to the element.

4. The storage compartment according to claim 1, wherein the movably guided support elements are movably guided in a circumferential direction of the storage region for the beverage container.

5. The storage compartment according to claim 1, wherein the driving device moves the second movably guided support element along only a portion of a path of the first movably guided support element.

6. The storage compartment according to claim 1, wherein the storage compartment comprises a further, fixed support element for laterally supporting a beverage container placed in a storage region of the storage compartment.

7. The storage compartment according to claim 1, wherein the support elements can be moved in a support direction, which is not the direction of the dividing movement or the return movement of the support elements, into the dividing position or into the home position, in the storage region and, in the opposite direction, out of the storage region.

8. The storage compartment according to claim 1, wherein the storage compartment comprises a mechanical control mechanism, which forces the support elements out of the storage region, counter to the support direction, during a movement of the first movably guided support element out of the dividing position and into the home position.

9. The storage compartment according to claim 8, wherein the mechanical control mechanism comprises a curve control.
